(19) United States
(12) Patent Application Publication
(10) Pub. No.: US 2015/0300090 A1
(43) Pub. Date: Oct. 22, 2015

(54) LADDER LIFT SYSTEM

(71) Applicant: Warren STRAND, Compton, IL (US)

(72) Inventor: Warren STRAND, Compton, IL (US)

(21) Appl. No.: 14/665,993

(22) Filed: Mar. 23, 2015

Related U.S. Application Data
(60) Provisional application No. 61/982,128, filed on Apr. 21, 2014.

(51) Int. Cl. E06C 1/38

(52) U.S. Cl. CPC E06C 1/38

(57) ABSTRACT

A manually-powered, adaptive ladder lift system for hoisting objects along a ladder to a predetermined height is provided. The ladder lift system may include a stop assembly, a trolley assembly, and a headstock assembly adapted to engage the ladder, whereby the trolley assembly rolls along the side rails of the ladder between the headstock assembly mounted to the top of the ladder and the stop assembly mounted to a lower portion thereof. The headstock assembly is adapted to various types and sizes of ladders. The stop assembly is adapted to retain the trolley assembly at the predetermined height anywhere between the stop assembly and the headstock assembly.

### CROSS-REFERENCE TO RELATED APPLICATION

This application claims the benefit of priority of U.S. provisional application No. 61/982,128, filed 21 Apr. 2014, the contents of which are herein incorporated by reference.

### BACKGROUND OF THE INVENTION

The present invention relates to ladder lifts and, more particularly, to a manually powered, adaptive ladder lift system for hoisting objects to a higher level.

During construction jobs, a construction worker typically has to use the ladder supplied by the lift company. As a result, the construction worker needs to use the ladder hoist also provided when wanting to lift an object to a predetermined height. Typical ladder hoists have the following disadvantages: they must travel all the way to the top of their assemblage to stop the object-carrying trolley, they are motor-powered and so come the attendant motor issues, they are complicated to attach to the ladder and must always be attended when in use, they are heavy and hard to move, they usually cannot be used as part of a scaffold system, they are expensive to buy and replace, they are limited to a specific dedicated ladder, and they need more storage space in your truck when transporting.

As can be seen, there is a need for a manually powered, adaptive ladder lift system for hoisting objects to a predetermined height. Wherein the object can be retained at any level along the ladder, where the system is adaptable to different types of ladders, and because of its manually-powered nature, is less expensive, lightweight and easier to store and transport.

### SUMMARY OF THE INVENTION

In one aspect of the present invention, a ladder lift system includes a headstock assembly configured to mount a top of a ladder; a head pulley coupled to the headstock assembly; a trolley assembly configured to ride along a pair of side rails of the ladder; an object shelf disposed along the trolley assembly, wherein the object shelf is oriented generally perpendicular to the pair of side rails; a stop assembly adapted to releasably retain the trolley assembly along the pair of side rails; and a stop pulley coupled to the stop assembly.

In another aspect of the present invention, a ladder lift system includes a head pulley coupled to a base box, wherein the base box is adapted to mount a top of a ladder; a trolley assembly adapted to ride along a pair of side rails of the ladder, the trolley assembly including: a base plate having a first side and a second side; an object shelf disposed along the first side, wherein the object shelf is oriented generally perpendicular to the pair of side rails; an cord eye disposed on the second side; a mounting frame attached to the second side; and a plurality of roller and guide wheel sets coupled to the mounting frame, each set including: a roller having a rotational axis oriented generally perpendicular to the base plate, wherein the roller is adapted to operatively engage a front surface of an adjacent side rail; and guide wheel having a rotational axis oriented generally parallel to the base plate, wherein each guide wheel provides a grove between its sidewalls so as to receive and operatively engage a portion of a side surface of the adjacent side rail; a stop assembly adapted to releasably retain the trolley assembly along the pair of side rails, the stop assembly including: a stop pulley coupled to the stop assembly; a cleat coupled to the stop assembly; at least one lower rung rest bracket and at least one upper rung rest bracket disposed on opposing vertical ends of the stop assembly; and a drive element attached to the trolley assembly and running over the head pulley and under the stop pulley.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use;

FIG. 2 is a detailed perspective view of an exemplary embodiment of the present invention;

FIG. 3 is a rear perspective view of an exemplary embodiment of the present invention;

FIG. 4 is an exploded view of an exemplary embodiment of the present invention;

FIG. 5 is a perspective view of an exemplary embodiment of the present invention;

FIG. 6 is a perspective view of an exemplary embodiment of the present invention;

FIG. 7 is a section view of an exemplary embodiment of the present invention, taken along line 7-7 in FIG. 3;

FIG. 8 is a perspective view of an exemplary embodiment of the present invention; and

FIG. 9 is a section view of an exemplary embodiment of the present invention, taken along line 9-9 in FIG. 3.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a manually-powered, adaptive ladder lift system for hoisting objects along a ladder to a predetermined height. The ladder lift system may include a stop assembly, a trolley assembly, and a headstock assembly adapted to engage the ladder, whereby the trolley assembly rolls along the side rails of the ladder between the headstock assembly mounted to the top of the ladder and the stop assembly mounted to a lower portion thereof. The headstock assembly is adapted to various types and sizes of ladders. The stop assembly is adapted to retain the trolley assembly at the predetermined height anywhere between the stop assembly and the headstock assembly.

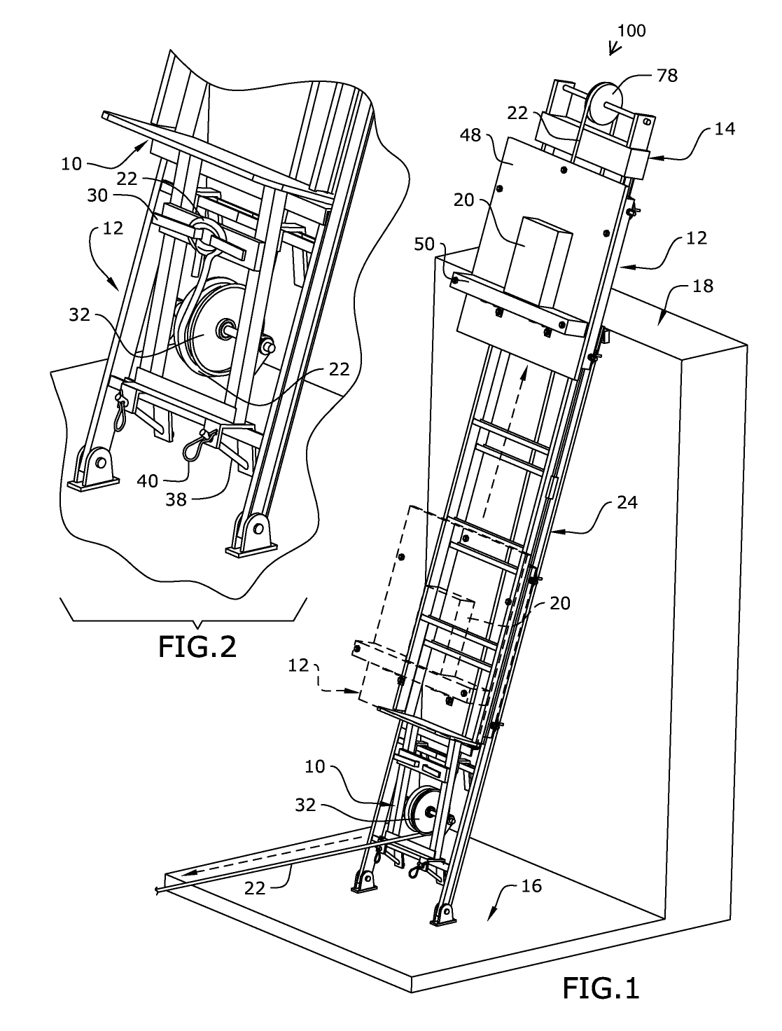

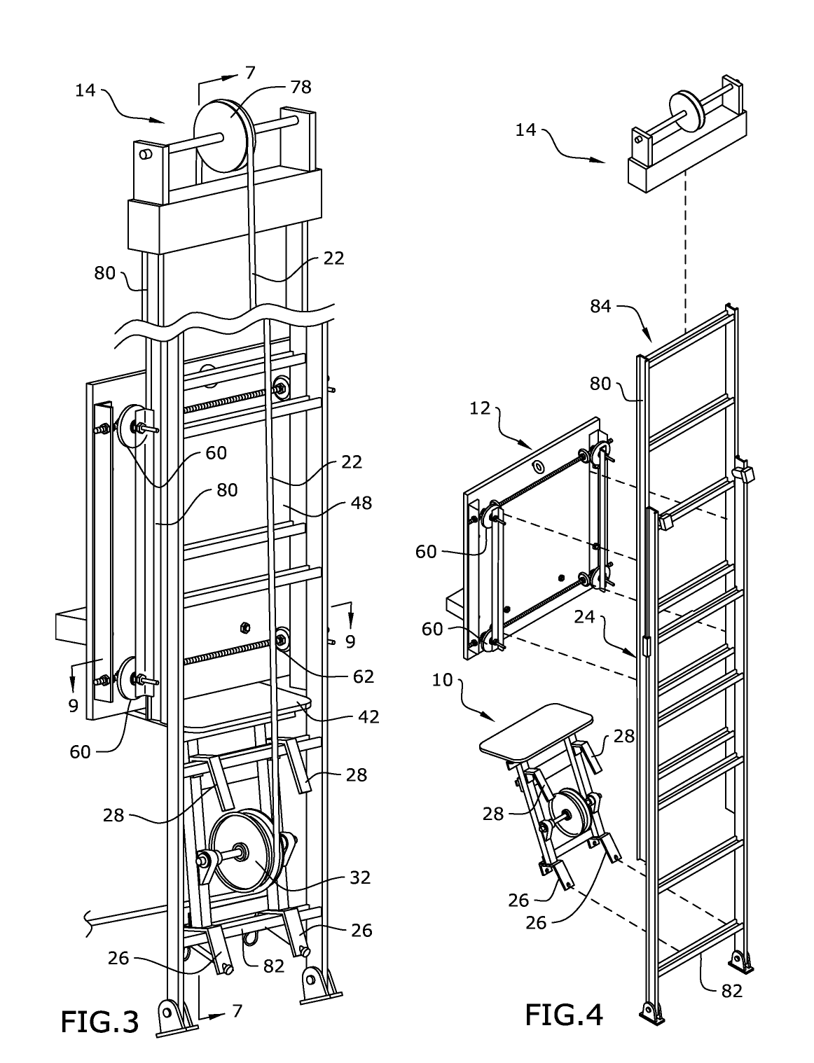

FIGS. 1 through 9 illustrate a manually-powered, adaptive ladder lift system 100 that embodies three separate elements that are combined for hoisting objects 20 to a higher level up and down an extension ladder 24, wherein the ladder 24 may be defined as a pair of spaced side rails 80 and a plurality of rungs 82 extending between the side rails 80.

The three elements of the ladder lift system 100 include a stop assembly 10, a trolley assembly 12 and a headstock assembly 14. The trolley assembly 12 may engage the ladder 24 while provide a surface for supporting the objects 20 being shuttled up and down the ladder 24. The headstock assembly 14 may be adapted to mount an upper portion of the ladder 24 for carrying the trolley assembly 12 up and down the ladder 24. The stop assembly 10 may be adapted to engage a lower portion of the ladder 24 for providing a platform to support the trolley assembly at its lowest point.

The stop assembly 10 may include an upwardly-facing platform 42 joined to a rectangular frame at an upper portion thereof. The upwardly-facing platform 42 may be adapted for supporting the trolley assembly 12 at its lowest point. A pair of generally parallel vertical frame members 45 and a pair of generally parallel horizontal frame members 44 extending between the pair of vertical frame members 45 may form the rectangular frame. Each horizontal frame member 44 may include, but not be limited to, an L-bracket that provides a horizontal support surface. The rectangular frame may include at least one lower rung rest bracket 26, at least one upper rung rest bracket 28, a pulley system, and a cleat 30.

At a lower portion of the rectangular frame, the horizontal support surface and the rectangular frame may be joined to at least one lower rung rest bracket 26 for removably securing to one ladder rung 82. Each lower rung rest bracket 26 may provide slots on each end of the bracket to removably engage a bracket pin 38. The bracket pin 38 may include a cotter pin 40 or the like to releasably secure the bracket pin 38 when engaging the one ladder rungs 82. At least one upper rung rest bracket 28 may be disposed near the upper portion of the rectangular frame. Each upper rung rest bracket 28 may be hooks for removably securing to a ladder rung 82. The cleat 30 may be disposed between the upper and lower portion of the rectangular frame. The cleat 30 may be adapted to retain a drive element 22 of the pulley system. The drive element 22 can be a rope, cable, belt, chain or the like that runs over the pulley inside its groove. The pulley system may be disposed between the upper and lower portion of the rectangular frame. The pulley system may include a stop pulley wheel 32 rotatably mounted to a stop pulley rod 34, wherein the stop pulley rod 34 may extend between the pair of vertical frame members 45. In certain embodiments, the stop pulley wheel 32 may be supported by bearings 36 that the stop pulley rod 34 is journaled through, as illustrated in FIG. 6. In certain embodiments, the stop pulley rod 34 may be connected by a pair of slugs 46 to the vertical frame members 45.

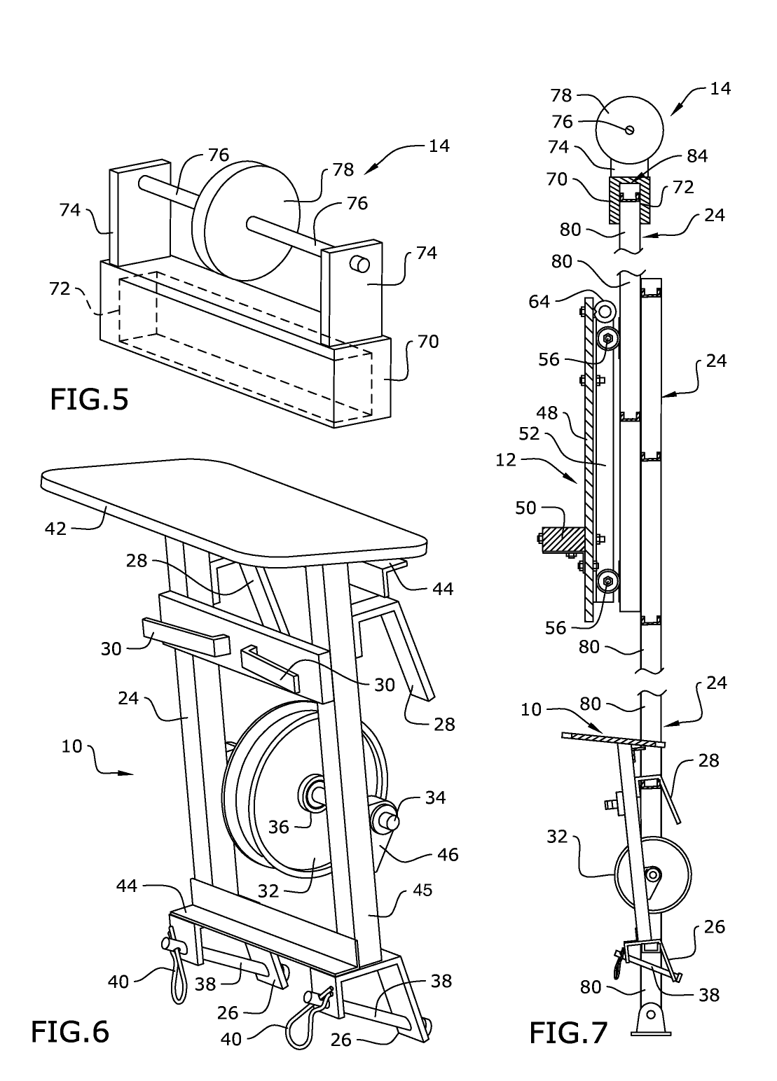

The headstock assembly 14 may include a base box 70 coupled to a head pulley wheel 78. The base box 70 may form a box cavity 72 dimensioned and adapted to mount to a top of various sized ladders 84, as illustrated in FIG. 4. The pulley wheel 78 may be rotatably mounted to a head pulley rod 78, wherein the head pulley rod 78 is coupled to the base box 70. In certain embodiments, the coupling may take to the form of a pair of opposing rising blocks 74 extending from the base box 70 so that the head pulley rod 18 may extend in between, as illustrated in FIG. 5.

The trolley assembly 12 may include a base plate 48 with an object shelf 50 disposed on a first side thereof, as illustrated in FIG. 7. The object shelf 50 is generally located closer to the bottom of the base plate 48 and in a plane generally oriented perpendicularly thereto. A mounting frame may be disposed on an opposing second side of the base plate 48 along the vertical edges thereof. In between the vertical edges of the second side of the base plate 48 may be disposed a cord eye 64 for receiving the drive element 22.

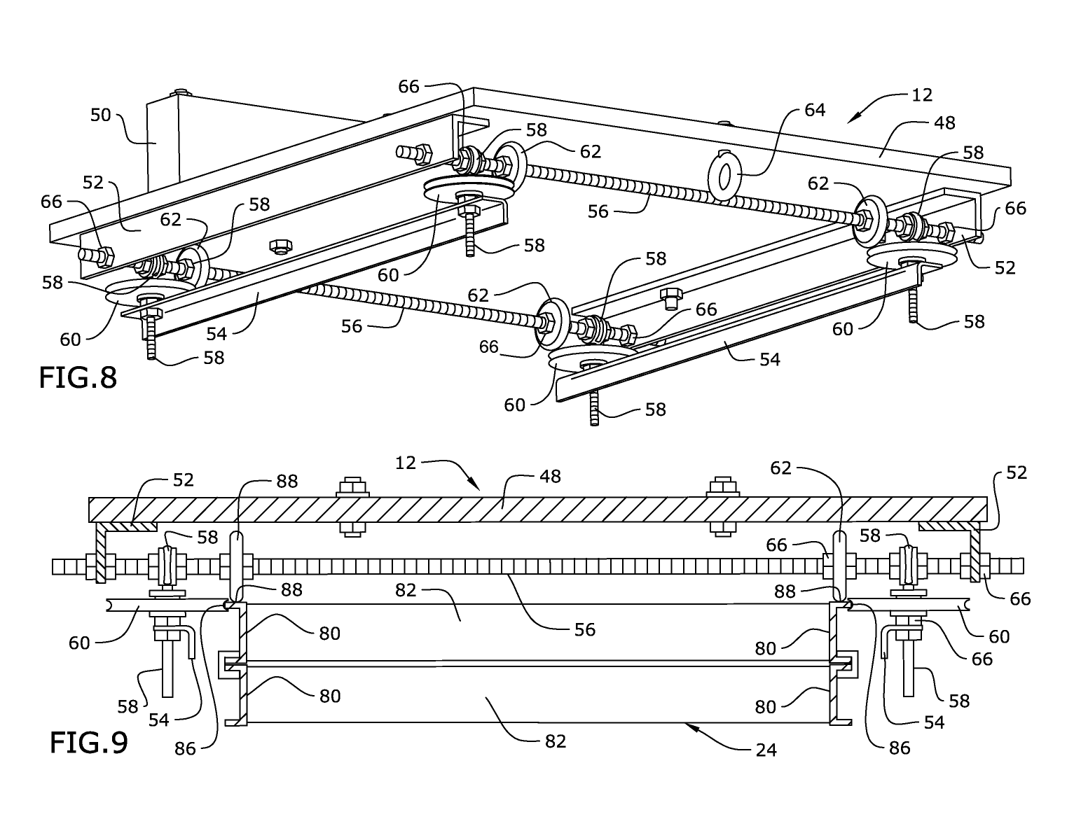

The mounting framing may include a pair of generally parallel board rails 52 disposed near a periphery of the base plate 48. A pair of frame rods 56 may extend between the pair of board rails 52. A pair of eyebolts 58 may be disposed near the opposing ends of each frame rod 56, wherein the frame rod 56 journals through the loop of each eyebolt 58. The bolt-portion of the eyebolt 58 may extend generally perpendicularly away from the second side of the base plate 48. Each bolt-portion may be rotatably mounted by a guide wheel 60, wherein each guide wheel 60 has a rotational axis oriented generally parallel to the base plate 48/mounting frame. In certain embodiments, a stabilizing rail 54 may extend between vertically oriented bolt-portions so as to retain and secure all guide wheels 60 thereto, within the same general planar orientation, as illustrated in FIGS. 8 and 9.

A roller 62 may be rotatably mounted to each frame rod 56 near each guide wheel 60, wherein each roller 62 has a rotational axis oriented generally perpendicular to the base plate 48/mounting frame. The relative positions of each roller 62 and adjacent guide wheel 60—or roller and guide wheel set—may be dimensioned and adapted so that each guide wheel 60 operatively engages a side surface 86 of the ladder rails 80 while each adjacent roller 62 operatively engages a front surface 88 of the same side rail 80 as illustrated in FIGS. 8 and 9. As such, the retained guide wheels 60 may be adapted to facilitate the interaction of the rollers 62 and the front surface 88 of the ladder's side rails 80. Each guide wheel may provide a grove between its sidewalls so as to receive a portion of the side surface 88, like a train track.

In certain embodiments, the frame rod 56 may be secured by fasteners 66 to each roller 62, board rail 52 and the like.

A method of using the present invention may include the following. The ladder lift system 100 disclosed above may be provided. A user wanting to lift an object 20 a predetermined distance above a grade surface 16 may place the ladder 24 on the grade surface, leaning the ladder 24 against a nearby supporting surface 18. Then the user may removably secure the stop assembly 10 along a lower pair of the ladder's rungs 82 by engaging the upper and lower rest brackets, 28, 26. Then the user may mount the headstock assembly 14 to the top of the ladder 84. The user may attach the trolley assembly 12 to the ladder 24 so that its rollers 62 and guide wheels 60 operatively engage the side rails 80, while the object shelf 50 supports the object 20.

The user may interconnect the stop assembly 10, the trolley assembly 12 and the headstock assembly with the drive element 22. One end of the drive element 22 may be secured to the cord eye 64, by being tied thereto, of the trolley assembly 12. The opposing end of the drive element 22 may extend upwardly to operatively engage the head pulley wheel 78, extend downwardly to operatively engage the stop pulley wheel 32, and extend from the stop pulley wheel 32 so as to be manually powered. In certain embodiments, the drive element 22 runs over the head pulley 78 and under the stop pulley 32. During use or after use, the opposing end of the drive element 22 can be secured to the cleat 30, so as secure the trolley assembly 12 and so the object 20 at the predetermined distance above the grade surface 16.

At its lowest point, the trolley assembly 12 rests on the stop platform 42 until the user pulls on the drive element 22 so as to raise and then lower the trolley assembly relative to the grade surface 16 to and from the predetermined distance.

It should be understood, of course, that the foregoing relates to exemplary embodiments of the invention and that modifications may be made without departing from the spirit and scope of the invention as set forth in the following claims.

What is claimed is:

1. A ladder lift system comprising:
a headstock assembly configured to mount a top of a ladder;
a head pulley coupled to the headstock assembly;
a trolley assembly configured to ride along a pair of side rails of the ladder;
an object shelf disposed along the trolley assembly, wherein the object shelf is oriented generally perpendicular to the pair of side rails;
a stop assembly configured to releasably retain the trolley assembly along the pair of side rails; and
a stop pulley coupled to the stop assembly.

2. The ladder lift system of claim 1, further comprising a drive element attached to the trolley assembly and running over the head pulley and under the stop pulley.

3. The ladder lift system of claim 1, wherein the trolley assembly further provides a mounting frame, wherein the mounting frame is rotatably coupled to a plurality of roller and guide wheel sets configured to ride along the pair of side rails, wherein each roller of the set has a rotational axis oriented generally perpendicular to the mounting frame, and wherein each guide wheel of the set has a rotational axis oriented generally parallel to the mounting frame.

4. The ladder lift system of claim 3, wherein each guide wheel of each set is configured to operatively engage the side surface of an adjacent side rail, and wherein each roller each set is configured to operatively engage the front surface of the adjacent side rail.

5. The ladder lift system of claim 4, wherein each guide wheel provides a grove between its sidewalls so as to receive a portion of the side surface, like a train track.

6. The ladder lift system of claim 3, wherein the mounting frame is coupled to a base plate, and wherein a cord eye is disposed on the base plate.

7. The ladder lift system of claim 1, further providing a cleat disposed on the stop assembly.

8. The ladder lift system of claim 1, wherein the headstock provides a base box forming a cavity for receiving the top of the ladder, wherein the cavity is configured to separately receive ladders of various sizes and types.

9. The ladder lift system of claim 1, further providing at least one lower rung rest bracket and at least one upper rung rest bracket disposed on opposing vertical ends of the stop assembly.

10. A ladder lift system comprising:
a head pulley coupled to a base box, wherein the base box is configured to mount a top of a ladder;
a trolley assembly configured to ride along a pair of side rails of the ladder, the trolley assembly comprising:
a base plate having a first side and a second side;
an object shelf disposed along the first side, wherein the object shelf is oriented generally perpendicular to the pair of side rails;
an cord eye disposed on the second side;
a mounting frame attached to the second side; and
a plurality of roller and guide wheel sets coupled to the mounting frame, each set comprising:
a roller having a rotational axis oriented generally perpendicular to the base plate, wherein the roller is adapted to operatively engage a front surface of an adjacent side rail; and
a guide wheel having a rotational axis oriented generally parallel to the base plate, wherein each guide wheel provides a grove between its sidewalls so as to receive and operatively engage a portion of a side surface of the adjacent side rail;
a stop assembly configured to releasably retain the trolley assembly along the pair of side rails, the stop assembly comprising:
a stop pulley coupled to the stop assembly;
a cleat coupled to the stop assembly; and
at least one lower rung rest bracket and at least one upper rung rest bracket disposed on opposing vertical ends of the stop assembly; and
a drive element attached to the trolley assembly and running over the head pulley and under the stop pulley.
